(19) United States
(12) Patent Application Publication
(10) Pub. No.: US 2010/0250299 A1
(43) Pub. Date: Sep. 30, 2010

(54) SELECTING A SERVICE ORIENTED ARCHITECTURE SERVICE

(75) Inventors: Kishore Channabasavaiah, Palatine, IL (US); Benjamin S. Gerber, Ann Arbor, MI (US); Sri Ramanathan, Lutz, FL (US); Mathew B. Trevathan, Kennesaw, GA (US); Raghu Varadan, San Francisco, CA (US); Nevenko Zunic, Hopewell Junction, NY (US)

Correspondence Address: Keohane & D'Alessandro, 1881 Western Avenue Suite 180, Albany, NY, 12203, US

(73) Assignee: International Business Machines Corporation, Armonk, NY (US)

(21) Appl. No.: 12/411,454

(22) Filed: Mar. 26, 2009

(51) Int. Cl. G06Q 10/00

(52) U.S. Cl. 705/7

(57) ABSTRACT

An approach that selects a service oriented architecture (SOA) service is provided. In one embodiment, there is a service selection tool, including an identification component configured to identify a process that affects a business objective, and identify a set of functional capabilities of the process. A selection component is configured to select a set of candidate SOA services based on the set of functional capabilities of the process.

### FIELD OF THE INVENTION

This invention relates generally to service oriented architecture (SOA) service, and more specifically to the selection of SOA services.

### BACKGROUND OF THE INVENTION

In the past, software architectures have attempted to deal with increasing levels of software complexity. As the level of complexity continues to increase, traditional architectures are reaching the limit of their ability to deal with various problems. At the same time, traditional needs of information technology (IT) organizations persist. IT organizations need to respond quickly to new requirements of the business, while continuing to reduce the cost of IT to the business by absorbing and integrating new business partners, new business sets, etc.

SOA is a new architectural style that enables modularization and externalization of both business and technical operations beyond traditional enterprise application models. SOA is an IT model which mirrors the interaction of business components through a set of IT applications implemented as real-time services that interact dynamically. This coupling of real-time services provides businesses greater flexibility and the ability to react to changes more efficiently.

However, while prior art organizations adopt and deploy SOA architectures, they lack the tools and techniques to assist users (e.g., business executives) in identifying potential service candidates derived from higher-level business goals. That is, business leaders may set the strategic objectives for a firm to increase their market share or increase profits per transaction, but these high level goals can not be decomposed into potential shared services from these high level statements with existing IT management processes. This lack of a decomposition and service identification capability severely impedes more widespread deployment and subsequent realization of SOA services benefits.

### SUMMARY OF THE INVENTION

In one embodiment, there is a method for selecting a service oriented architecture (SOA) service. In this embodiment, the method comprises: identifying a process that affects a business objective; identifying a set of functional capabilities of the process; and selecting a set of candidate SOA services based on the set of functional capabilities of the process.

In a second embodiment, there is a system for selecting a service oriented architecture (SOA) service. In this embodiment, the system comprises at least one processing unit, and memory operably associated with the at least one processing unit. A service selection tool is storable in memory and executable by the at least one processing unit. The service selection tool comprises: an identification component configured to identify a process that affects a business objective, and identify a set of functional capabilities of the process. A selection component is configured to select a set of candidate SOA services based on the set of functional capabilities of the process.

In a third embodiment, there is a computer-readable medium storing computer instructions, which when executed, enables a computer system to select a service oriented architecture (SOA) service, the computer instructions comprising: identifying a process that affects a business objective; identifying a set of functional capabilities of the process; and selecting a set of candidate SOA services based on the set of functional capabilities of the process.

In a fourth embodiment, there is a method for deploying a service selection tool for use in a computer system that provides selection of a service oriented architecture (SOA) service. In this embodiment, a computer infrastructure is provided and is operable to: identify a process that affects a business objective; identify a set of functional capabilities of the process; and select a set of candidate SOA services based on the set of functional capabilities of the process.

### BRIEF DESCRIPTION OF THE DRAWINGS

FIG. 1 shows a schematic of an exemplary computing environment in which elements of the present invention may operate;

FIG. 2 shows a service selection tool that operates in the environment shown in FIG. 1; and

FIG. 3 shows a flow diagram of an embodiment of the invention for selecting a SOA service.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Embodiments of this invention are directed to selecting service oriented architecture (SOA) services. In these embodiments, the method comprises: identifying a process that affects a business objective; identifying a set of functional capabilities of the process; and selecting a set of candidate SOA services based on the set of functional capabilities of the process. In one embodiment, a service selection tool provides this capability.

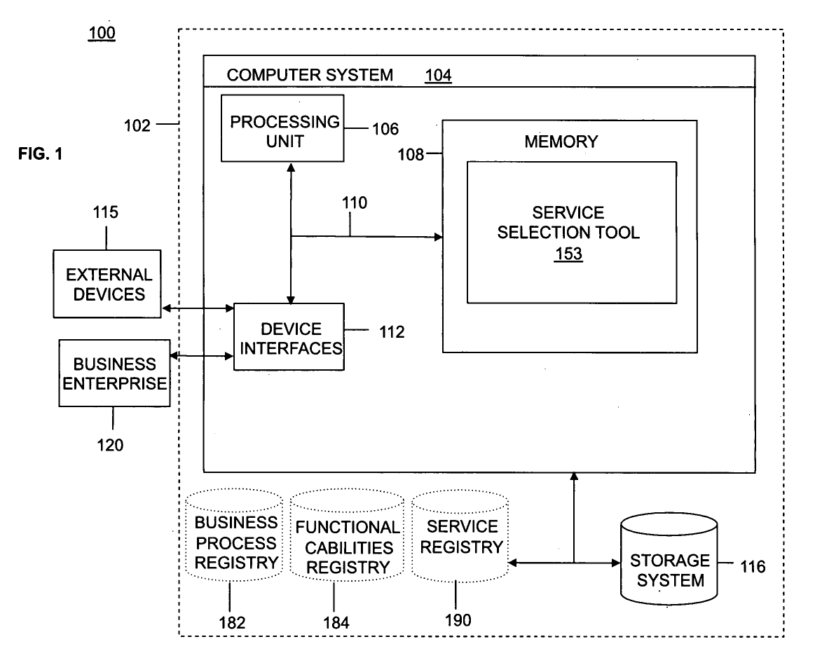

FIG. 1 illustrates a computerized implementation 100 of the present invention. As depicted, implementation 100 includes computer system 104 deployed within a computer infrastructure 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 102 is intended to demonstrate that some or all of the components of implementation 100 could be deployed, managed, serviced, etc., by a service provider who offers to implement, deploy, and/or perform the functions of the present invention for others.

Computer system 104 is intended to represent any type of computer system that may be implemented in deploying/realizing the teachings recited herein. In this particular example, computer system 104 represents an illustrative system for selecting a SOA service. It should be understood that any other computers implemented under the present invention may have different components/software, but will perform similar functions. As shown, computer system 104 includes a processing unit 106, memory 108 for storing a service selection tool 153, a bus 110, and device interfaces 112.

Processing unit 106 collects and routes signals representing outputs from external devices 115 (e.g., a keyboard, a pointing device, a display, a graphical user interface, etc.) to service selection tool 153. The signals can be transmitted over a LAN and/or a WAN (e.g., T1, T3, 56 kb, X.25), broadband connections (ISDN, Frame Relay, ATM), wireless links (802.11, Bluetooth, etc.), and so on. In some embodiments, the signals may be encrypted using, for example, trusted key-pair encryption. Different external devices may transmit information using different communication pathways, such as Ethernet or wireless networks, direct serial or parallel connections, USB, Firewire®, Bluetooth®, or other proprietary interfaces. (Firewire is a registered trademark of Apple Computer, Inc. Bluetooth is a registered trademark of Bluetooth Special Interest Group (SIG)).

In general, processing unit 106 executes computer program code, such as program code for operating service selection tool 153, which is stored in memory 108 and/or storage system 116. While executing computer program code, processing unit 106 can read and/or write data to/from memory 108, storage system 116, a service registry 190, a functional capabilities registry 184, and a process registry 182. In this way, each of functional capabilities registry 184, process registry 182, and service registry 190 are adaptive, updatable, and self-learning. Service registry 190 stores a plurality of SOA services and associated metadata within a portfolio, as well as rules against which the metadata is compared to locate, update, and store SOA services. The storage system and the registries can include VCRs, DVRs, RAID arrays, USB hard drives, optical disk recorders, flash storage devices, or any other similar storage device. Although not shown, computer system 104 could also include I/O interfaces that communicate with one or more external devices 115 that enable a user to interact with computer system 104.

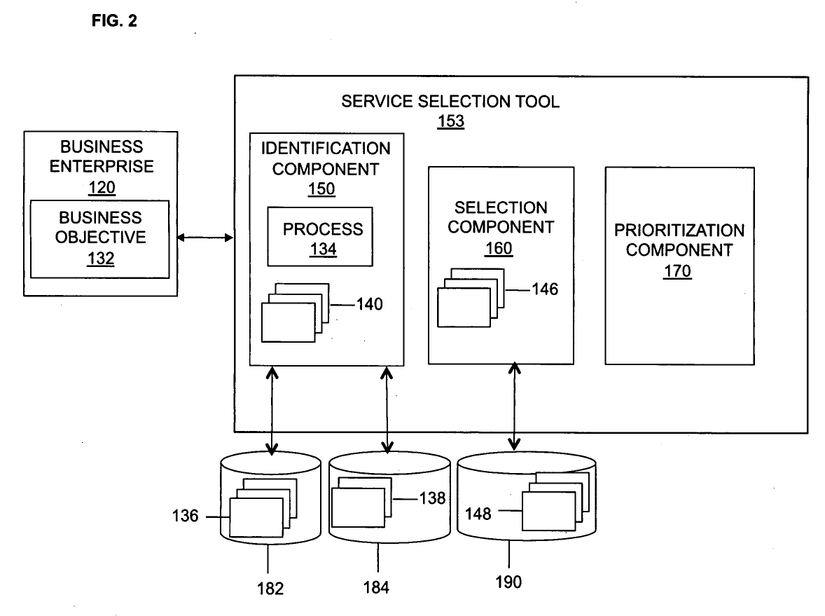

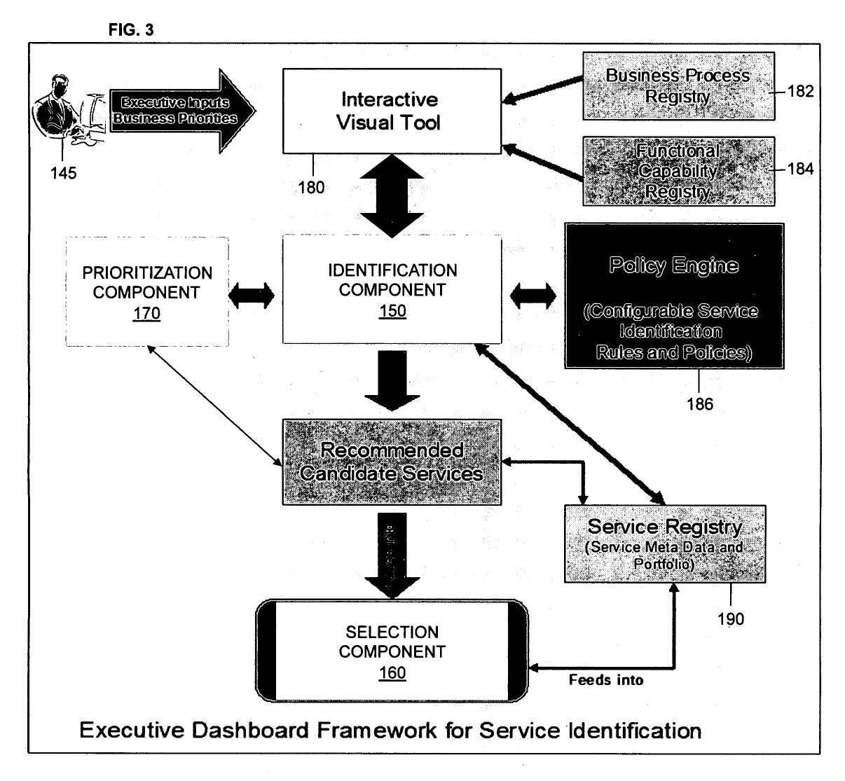

FIGS. 2-3 show a more detailed view of service selection tool 153, which selects a SOA service (e.g., an IT application that can be re-used/applied across multiple or different applications to address a business need) based on detailed requirements of a process. As shown, service selection tool 153 comprises an identification component 150 configured to identify a process 134 (e.g., a business process) that is influenced by a business objective 132, which may be any variety of business strategies, goals, etc. For example, a business enterprise 120 may outline a business objective to increase sales to current customers, including analyzing customer data, financials, and product usage to develop specific marketing approaches, etc. In this case, identification component 150 is configured to provide a plurality of processes 136 influenced by business objective 132 to a user 145, for example, using an interactive visual tool 180 (FIG. 3). User 145 (e.g., a business executive/manager) is presented with a list of processes (e.g., via a drop down menu, or by selecting points or areas on a visual map of a business organization's structure, operations, or process) from which one or more processes can be selected.

Plurality of processes 136 may be stored in business process registry 182, and can be used to pre-fill interactive visual tool 180 with a plurality of processes for user 145 to select. Interactive visual tool 180 may also be pre-filled with strategy related policies, business domain and process policies, common domain functionality sharing policies, etc. Based on input provided by user 145, identification component 150 is configured to select process 134 from plurality of processes 136 that affect business objective 132. In one embodiment, user 145 can be guided to select an applicable process by answering a series of questions about the user's business objectives even if the precise process that performs the target function(s) is unknown by the user. Business patterns are mapped to probable processes to guide the user's selections in this guided mode of operation.

Once the process selection is made, identification component 150 is configured to identify the functional capabilities (i.e., attributes or executable actions) of process 134. Specifically, identification component 150 is configured to provide a plurality of functional capabilities 138 of process 134 that are affected by business objective 132 to user 145. User 145 is presented with a list of functional capabilities for the process, for example, via a drop-down menu. Identification component 150 is configured to select a set of functional capabilities 140 of process 134 from plurality of functional capabilities 138 of process 134 presented to user 145. In one embodiment, identification component 150 operates with a policy engine 186, which contains a number of configurable service identification rules and policies for evaluating each functional capability. Policy engine 186 ranks the functional capabilities by enterprise, program goals/objectives, current state versus desired state, etc.

Once the functional capabilities are selected, they are used by a selection component 160 to identify candidate SOA services. Specifically, selection component 160 is configured to select a set of candidate SOA services 146 based on set of functional capabilities 140 of process 134. In one embodiment, set of candidate SOA services 146 is selected from services registry 190, which contains a plurality of existing SOA services 148. Set of candidate services 146 is then presented to user 45 via interactive visual tool 180. In one embodiment, service selection tool 153 further comprises a prioritization component 170 configured to prioritize each of set of candidate SOA services 146. That is, user 145 may assign a priority level for each strategic initiative after the first two criteria selections (i.e., business process and functional capabilities) have been made. This allows executives and organizations to prioritize which services and/or business processes are modified or built first based on business priorities.

As described herein, the present invention provides an interactive process for identifying candidate SOA services that can be used to fulfill business strategies and objectives by selecting affected business processes and their functional attributes or capabilities. The present invention promotes sharing of resources and services by abstracting the service away from the line of business, thereby increasing the efficiency of the organization.

Further, it will be appreciated that service selection tool 153 of the present invention is adaptable and self-learning, in that it dynamically improves over time in making specific recommendations based on adjustments to changing environmental factors. Self-learning is achieved in a variety of ways, including by performing analytics of data flows occurring within identification component 150 and selection component 160, as well as analytics of the rules-based decision process.

It can be appreciated that the methodologies disclosed herein can be used within a computer system to provide selection of a SOA service, as shown in FIG. 1. In this case, service selection tool 153 can be provided, and one or more systems for performing the processes described in the invention can be obtained and deployed to computer infrastructure 102. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the invention.

The exemplary computer system 104 may be described in the general context of computer-executable instructions, such as program modules, being executed by a computer. Generally, program modules include routines, programs, people, components, logic, data structures, and so on that perform particular tasks or implements particular abstract data types. Exemplary computer system 104 may be practiced in distributed computing environments where tasks are performed by remote processing devices that are linked through a communications network. In a distributed computing environment, program modules may be located in both local and remote computer storage media including memory storage devices.

Furthermore, an implementation of exemplary computer system 104 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this invention an approach for selecting a SOA service. While the invention has been particularly shown and described in conjunction with a preferred embodiment thereof, it will be appreciated that variations and modifications will occur to those skilled in the art. Therefore, it is to be understood that the appended claims are intended to cover all such modifications and changes that fall within the true spirit of the invention.

What is claimed is:

1. A method for selecting a service oriented architecture (SOA) service comprising:
identifying a process that affects a business objective;
identifying a set of functional capabilities of the process; and
selecting a set of candidate SOA services based on the set of functional capabilities of the process.

2. The method according to claim 1, the identifying a process comprising:
providing a plurality of processes that affect the business objective to a user; and
selecting the process from the plurality of processes.

3. The method according to claim 2, the identifying a set of functional capabilities comprising:
providing a plurality of functional capabilities of the process that affect the business objective to the user; and
selecting the set of functional capabilities of the process from the plurality of functional capabilities of the process.

4. The method according to claim 1, the selecting comprising selecting the set of candidate SOA services from a services registry containing a plurality of existing SOA services.

5. The method according to claim 1 further comprising prioritizing each of the set of candidate SOA services.

6. A system for selecting a service oriented architecture (SOA) service comprising:
at least one processing unit;
memory operably associated with the at least one processing unit; and
a service selection tool storable in memory and executable by the at least one processing unit, the service selection tool comprising:
an identification component configured to:
identify a process that affects a business objective;
identify a set of functional capabilities of the process; and
a selection component configured to select a set of candidate SOA services based on the set of functional capabilities of the process.

7. The service selection tool according to claim 6, the identification component further configured to:
provide a plurality of processes that affect the business objective to a user; and
select the process from the plurality of processes.

8. The service selection tool according to claim 7, the identification component further configured to:
provide a plurality of functional capabilities of the process that affect the business objective to the user; and
select the set of functional capabilities of the process from the plurality of functional capabilities of the process.

9. The service selection tool according to claim 6, the selection component further configured to select the set of candidate SOA services from a services registry containing a plurality of existing SOA services.

10. The service selection tool according to claim 6 further comprising a prioritization component configured to prioritize each of the set of candidate SOA services.

11. A computer-readable medium storing computer instructions, which when executed, enables a computer system to select a service oriented architecture (SOA) service, the computer instructions comprising:
identifying a process that affects a business objective;
identifying a set of functional capabilities of the process; and
selecting a set of candidate SOA services based on the set of functional capabilities of the process.

12. The computer-readable medium according to claim 11, the computer instructions for identifying a process further comprising:
providing a plurality of processes that affect the business objective to a user; and
selecting the process from the plurality of processes.

13. The computer-readable medium according to claim 12, the computer instructions for identifying a set of functional capabilities further comprising:
providing a plurality of functional capabilities of the process that affect the business objective to the user; and
selecting the set of functional capabilities of the process from the plurality of functional capabilities of the process.

14. The computer-readable medium according to claim 11, the computer instructions for selecting further comprising selecting the set of candidate SOA services from a services registry containing a plurality of existing SOA services.

15. The computer readable medium according to claim 11, further comprising computer instructions for prioritizing each of the set of candidate SOA services.

16. A method for deploying a service selection tool for use in a computer system that provides selection of a service oriented architecture (SOA) service, comprising:
providing a computer infrastructure operable to:
identify a process that affects a business objective;
identify a set of functional capabilities of the process; and
select a set of candidate SOA services based on the set of functional capabilities of the process.

17. The method according to claim 16, the computer infrastructure operable to identify a process further operable to:
provide a plurality of processes that affect the business objective to a user; and
select the process from the plurality of processes.

18. The method according to claim 17, the computer infrastructure operable to identify a set of functional capabilities further operable to:
provide a plurality of functional capabilities of the process that affect the business objective to the user; and
select the set of functional capabilities of the process from the plurality of functional capabilities of the process.

19. The method according to claim 16, the computer infrastructure operable to select further operable to select the set of candidate SOA services from a services registry containing a plurality of existing SOA services.

20. The method according to claim 16, the computer infrastructure further operable to prioritize each of the set of candidate SOA services.
